(19) United States
(12) Patent Application Publication
(10) Pub. No.: US 2026/0177326 A1
(43) Pub. Date: Jun. 25, 2026

(54) PANELS WITH INTEGRAL THERMAL CONTROL AND METHODS

(71) Applicant: The Boeing Company, Arlington, VA (US)

(72) Inventors: Richard W. Aston, Steilacoom, WA (US); Mara Pearson, Seattle, WA (US); Emily C. Woods, Redondo Beach, CA (US)

(73) Assignee: The Boeing Company, Arlington, VA (US)

(21) Appl. No.: 18/989,559

(22) Filed: Dec. 20, 2024

(51) Int. Cl. F28D 15/02; B33Y 80/00; B64D 47/00

(52) U.S. Cl. CPC F28D 15/0266; B64D 47/00; B33Y 80/00

(57) ABSTRACT

A panel assembly includes a plurality of panels. Each one of the panels includes a first face sheet, a second face sheet, a truss structure connecting the first face sheet and the second face sheet, and a perimeter edge. The panel assembly also includes a primary splice connector that is connected to the first face sheet and the second face sheet along at least a portion of the perimeter edge of directly adjacent ones of the panels. The primary splice connector includes a heat exchanger.

### FIELD

The present disclosure relates generally to panel structures and, more particularly, to additively manufactured panels having integral thermal control and methods for manufacturing panels.

### BACKGROUND

Electrical equipment is used for a variety of purposes. Often, electrical equipment is organized and secured using racks or other support structures. However, in certain applications, such as aerospace and other mobile applications, conventional equipment racks are too heavy. In such applications, electrical equipment is often mounted to composite substrates or composite honeycomb panels to reduce weight. However, such composite panels are expensive and require long lead times. Additionally, electrical equipment often generates heat and most conventional panel structures do not have thermal control or heat transfer (e.g., spreading) capabilities. Some existing honeycomb sandwich composite panels include embedded heat pipes. However, such panels are more expensive and require even longer lead times. Accordingly, those skilled in the art continue with research and development efforts in the field of panel assemblies for supporting functional equipment.

### SUMMARY

Disclosed are examples of a panel assembly, an equipment array, and method for manufacturing and using a panel assembly. The following is a non-exhaustive list of examples, which may or may not be claimed, of the subject matter according to the present disclosure.

In an example, the disclosed panel assembly includes a plurality of panels. Each one of the panels includes a first face sheet, a second face sheet, a truss structure connecting the first face sheet and the second face sheet, and a perimeter edge. The panel assembly also includes a primary splice connector that is connected to the first face sheet and the second face sheet along at least a portion of the perimeter edge of directly adjacent ones of the panels. The primary splice connector includes a heat exchanger.

In another example, the disclosed equipment array includes a plurality of panels. Each one of the panels includes a first face sheet, a second face sheet, a truss structure connecting the first face sheet and the second face sheet, and a perimeter edge. The equipment array also includes a primary splice connector that is connected to the first face sheet and the second face sheet along at least a portion of the perimeter edge of directly adjacent ones of the panels. The primary splice connector includes a heat exchanger. The equipment array further includes equipment that is coupled to at least one of the first face sheet and the second face sheet of at least one of the panels.

In an example, the disclosed method includes steps of: (1) manufacturing a plurality of panels, each one of the panels includes a first face sheet, a second face sheet, a truss structure connecting the first face sheet and the second face sheet, and a perimeter edge; and (2) connecting each one of the panels to a directly adjacent one of the panels along at least a portion of the perimeter edge using a primary splice connector. The primary splice connector includes a heat exchanger. The method also includes steps of: (3) coupling equipment to at least one of the panels; and (4) transferring heat along the panels via the heat exchanger of the primary splice connector.

Other examples of the panel assembly, equipment array, and method will become apparent from the following detailed description, the accompanying drawings, and the appended claims.

### BRIEF DESCRIPTION OF THE DRAWINGS

FIG. 1 is a schematic block diagram of an example of a panel assembly;

FIG. 2 is a flow diagram of an example of a method for manufacturing and using a panel;

FIG. 3 is a schematic, perspective view of an example of the panel assembly;

FIG. 4 is a schematic, exploded perspective view of an example of the panel assembly;

FIG. 5 is a schematic, perspective view of an example of a primary splice connector of the panel assembly;

FIG. 6 is a schematic, section view of an example of a portion of the panel assembly and a primary splice connector;

FIG. 7 is a schematic, plan view of an example of a portion of the panel assembly and a secondary splice connector;

FIG. 8 is a schematic, section view of an example of a portion of an equipment array;

FIG. 9 is a schematic block diagram of an example of an aerospace platform; and

FIG. 10 is a flow diagram of an example of a manufacturing and service method.

### DETAILED DESCRIPTION

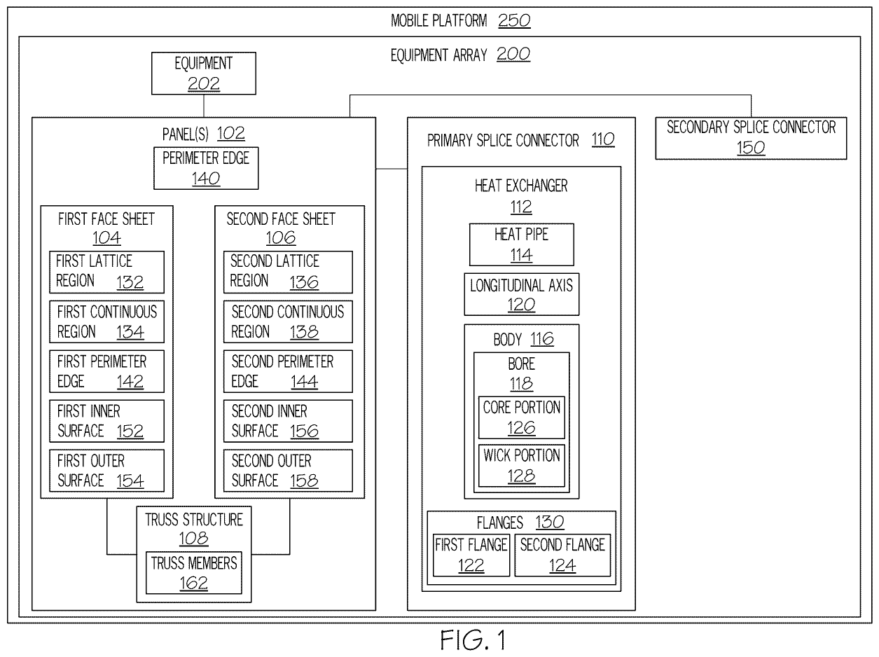

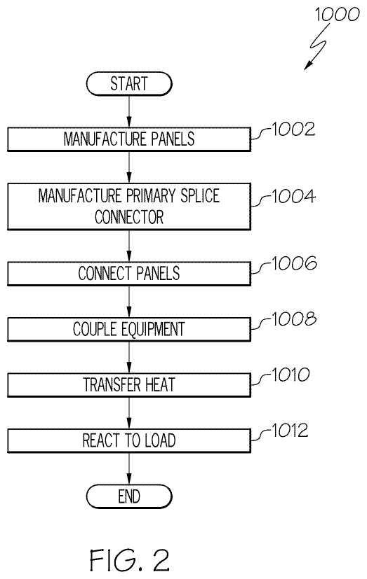

Referring now to FIGS. 1 and 3-7 by way of examples, the present disclosure is directed to a panel assembly 100. The following are examples of the panel assembly 100, according to the present disclosure. Examples of the panel assembly 100 include a number of elements, features, and components. In one or more examples, the panel assembly 100 is constructed or otherwise fabricated according to a method 1000 (FIG. 2). Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

As will be described in more detail, examples of the panel assembly 100 expand and improve applicable uses for various panel structures and, more specifically, for additively manufactured micro-truss panels, by providing integral passive thermal control to an assembly of the panels. Passive thermal control is accomplished by incorporating a heat exchanger, such as an ammonia filled heat pipe, within splice connectors used to interconnect a plurality of panels. As such, the panel assembly 100 provides a unique and advantageous thermal control and heat transfer function via the heat exchanger (e.g., heat pipe) while also serving as the structural splice between adjacent panels. Examples of the panel assembly 100 provide significant cost and lead time reduction compared to a conventional composite sandwich panel with thermal control function. Additionally, the panel assembly 100 provides an entirely mechanically fastened construction, which eliminates workmanship sensitive bonding operations, autoclave curing, long-lead foaming adhesives, and mechanical proof loading.

In various examples, the panel assembly 100 includes a plurality of additively manufactured panels that include a pair of face sheets connected by a micro-truss core structure. In various examples, at least a portion of one or both of the face sheets includes a lattice structure. In various examples, at least another portion of one or both of the face sheets include a continuous or solid structure. In various examples, the panels are joined via one or more splice connectors. In various examples, one or more of the splice connectors include an integral thermal transfer element for controlling heat transfer along and/or through the panels. In various examples, the panels and splice connectors facilitate modularity in the arrangement and use of the panel assembly 100.

As illustrated in FIGS. 1, 3, 4 and 6-8, in one or more examples, the panel assembly 100 includes a plurality of the panels 102. Each one of the panels 102 includes a first face sheet 104, a second face sheet 106, and a truss structure 108 that connects the first face sheet 104 and the second face sheet 106. Each one of the panels 102 also includes a perimeter edge 140.

In one or more examples, each of the panels 102 is additively manufactured from a metallic alloy using laser powder fusion. In one or more examples, the truss structure 108 includes a plurality of truss members 162. Each one of the truss members 162 is integral with the first face sheet 104 and the second face sheet 106 such that the first face sheet 104, the second face sheet 106, and the truss structure 108 collectively form a single monolithic joint-free structure.

As illustrated in FIGS. 1, 3, 4, 6 and 8, in one or more examples, the first face sheet 104 includes a first lattice region 132, a first continuous region 134; a first perimeter edge 142, a first inner surface 152, and a first outer surface 154. The first continuous region 134 extends along at least a portion of the first perimeter edge 142. The first flange 122 is coupled to the first continuous region 134. As an example, the first flange 122 is coupled to the first inner surface 152. In one or more examples, portions of the first lattice region 132 and the first continuous region 134 form the first inner surface 152 and the first outer surface 154. In other examples, portions of the first continuous region 134 form the first inner surface 152 and the first outer surface 154.

As illustrated in FIGS. 1, 3, 4, 6 and 8, in one or more examples, the second face sheet 106 includes a second lattice region 136, a second continuous region 138; a second perimeter edge 144, a second inner surface 156, and a second outer surface 158. The second continuous region 138 extends along at least a portion of the second perimeter edge 144. The second flange 124 is coupled to the second continuous region 138. As an example, the second flange 124 is coupled to the second inner surface 156. In one or more examples, portions of the second lattice region 136 and the second continuous region 138 form the second inner surface 156 and the second outer surface 158. In other examples, portions of the second continuous region 138 form the second inner surface 156 and the second outer surface 158.

As illustrated in FIGS. 1, 3-6 and 8, in one or more examples, the panel assembly 100 includes a primary splice connector 110. The panel assembly 100 can include any number (e.g., one or more) of primary splice connectors 110. The primary splice connector 110 is configured to react to a structural load across the panels 102. The primary splice connector 110 is connected to at least one of the first face sheet 104 and the second face sheet 106 along at least a portion (e.g., first portion) of the perimeter edge 140 of directly adjacent ones of the panels 102 for connecting and securing together the of directly adjacent ones of the panels 102. In one or more examples, at least one of the primary splice connectors 110 is connected to the first face sheet 104 and is connected to the second face sheet 106. In one or more examples, the primary splice connector 110 is coupled to first continuous region 134 of the first face sheet 104 along a first portion of the first perimeter edge 142 and is coupled to the second continuous region 138 of the second face sheet 106 along a second portion of the second perimeter edge 144. The primary splice connector 110 is coupled to the first inner surface 152 of the first face sheet 104 and to the second inner surface 156 of the second face sheet 106.

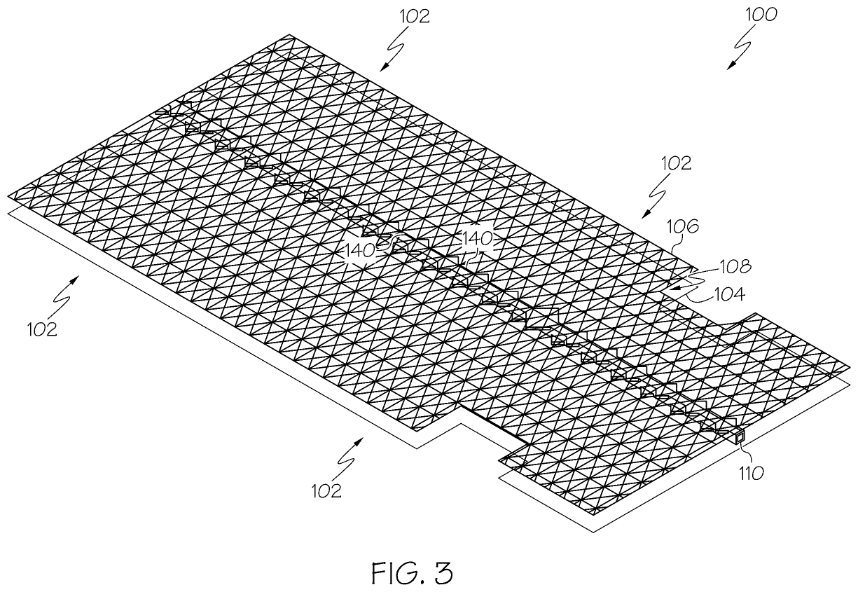

As illustrated in FIGS. 3, 4, 6 and 8, in one or more examples, the primary splice connector 110 is situated and extends between the first face sheet 104 and the second face sheet 106. For example, the primary splice connector 110 extends between the first inner surface 152 of the first face sheet 104 and the second inner surface 156 of the second face sheet 106. In one or more examples, the primary splice connector 110 runs along at least a portion of the perimeter edges 140 of the directly adjacent panels 102 and extends across an interface between the perimeter edges 140 of the directly adjacent panels 102. In one or more examples, the primary splice connector 110 runs along at least a portion of the first perimeter edges 142 of the first face sheets 104 of the directly adjacent panels 102 and extends across an interface between the first perimeter edges 142 of the first face sheets 104 of the directly adjacent panels 102. In one or more examples, the primary splice connector 110 runs along at least a portion of the second perimeter edges 144 of the second face sheets 106 of the directly adjacent panels 102 and extends across an interface between the second perimeter edges 144 of the second face sheets 106 of the directly adjacent panels 102. In one or more examples, the primary splice connector 110 is situated between the truss structures 108 of the directly adjacent panels 102.

In one or more examples, the first face sheets 104 and/or the second face sheets 106 being spliced together along a portion of the perimeter edges 140 using primary splice connector 110 facilitates the transfer load and precludes four bar linkage mechanism behavior. In one or more examples, the finger-doubler shape (e.g., squares or diamonds connected by rectangular strap sections) of the primary splice connector 110 is configured to match the shape (e.g., square) of adjoined grids of the first continuous regions 134 of adjacent first face sheets 104 and the second continuous regions 138 of the second face sheets 106.

In one or more examples, the first face sheets 104 and/or the second face sheets 106 being spliced together along a portion of the perimeter edges 140 using primary splice connector 110 also facilitates the transfer of panel-to-panel shear. In one or more examples, the shape (e.g., square or diamond) of the first flanges 122 and the second flanges 124 is configured to match the shape (e.g., square) of adjoined grids of the first continuous regions 134 and/or the second continuous regions 138 of adjacent panels 102.

As illustrated in FIGS. 1, 3-5 and 7, in one or more examples, the primary splice connector 110 includes a heat exchanger 112. In these examples, the primary splice connector 110 and, more particularly, the heat exchanger 112 is configured to transfer heat along the panels 102. The heat exchanger 112 can include or take the form of any suitable device configured to transfer heat between two or more materials. In one or more examples, the heat exchanger 112 includes a heat pipe 114. The heat pipe 114 is configured to utilize phase change and thermal conductivity to move heat from one location to another with minimal temperature difference. As an example, the heat pipe 114 is a fluid filled (e.g., ammonia filled) heat pipe. As such, the heat pipe 114 of the primary splice connector 110 provides efficient heat dissipation and/or distribution along a connection interface between adjacent panels 102 and/or through the thickness of the panel 102.

As illustrated in FIGS. 1, 4-6 and 8, in one or more examples, the primary splice connector 110 includes a body 116. The body 116 includes a longitudinal axis 120 and a bore 118 that extends along the longitudinal axis 120. The bore 118 includes a core portion 126 and a wick portion 128 that is coupled to the core portion 126. In these examples, the body 116 (e.g., the core portion 126 and the wick portion 128) forms the structure of the heat pipe 114. In other words, the heat exchanger 112 (e.g., heat pipe 114) includes the body 116 with the bore 118 that extends along the longitudinal axis 120 and includes the core portion 126 and the wick portion 128.

In various examples, the body 116 of the primary splice connector 110 (e.g., the heat pipe 114) can be made of any suitable material, typically a material with a high thermal conductivity, such as copper, aluminum, or stainless steel. The body 116 provides structural integrity for containing the working fluid and vapor within the bore 118 and conducts heat to and from the panels 102 to which the primary splice connector 110 is connected. The body 116 also provides structural integrity at the joining interface between the directly adjacent (e.g., connected) ones of the panels 102. In one or more examples, the core portion 126 forming the bore 118 is cylindrical. However, in other examples, the core portion 126 forming the bore 118 can be flattened or have other custom shapes depending on the application. In various examples, the working fluid of the heat pipe 114 is water, ammonia, alcohol, or other specialized fluid. The bore 118 is sealed at both ends and is evacuated of air to create a vacuum. The wick portion 128 can have any suitable structure and/or be made of any suitable material. In the illustrated examples, the wick portion 128 includes or takes the form of a plurality of radial grooves 148 formed in the core portion 126 and extending along the length of the bore 118. However, in other examples, the wick portion 128 can include sintered metal, wire mesh, or other porous materials. The wick portion 128 facilitates capillary action to ensure continuous cycling of the working fluid between the condenser section and the evaporator section of the heat pipe 114.

As illustrated in FIGS. 1, 4-6 and 8, in one or more examples, the primary splice connector 110 also includes a first flange 122 and a second flange 124. The first flange 122 extends outwardly from the body 116 and is coupled to (e.g., is configured to be coupled to) the first face sheet 104. The second flange 124 extends outwardly from the body 116 and is coupled to (e.g., is configured to be coupled to) the second face sheet 106. The first flange 122 facilitates connection to the first face sheets 104 of the directly adjacent panels 102 along the first perimeter edges 142. As an example, a plurality of first flanges 122 are coupled to the first inner surface 152 of the first continuous region 134 of the first face sheet 104 along at least a portion of the first perimeter edge 142 of each of the adjacent panels 102 to be connected together. The second flange 124 facilitates connection to the second face sheets 106 of the directly adjacent panels 102 along the second perimeter edges 144. As an example, a plurality of second flanges 124 are coupled to the second inner surface 156 of the second continuous region 138 of the second face sheet 106 along at least a portion of the second perimeter edge 144 of each of the adjacent panels 102 to be connected together.

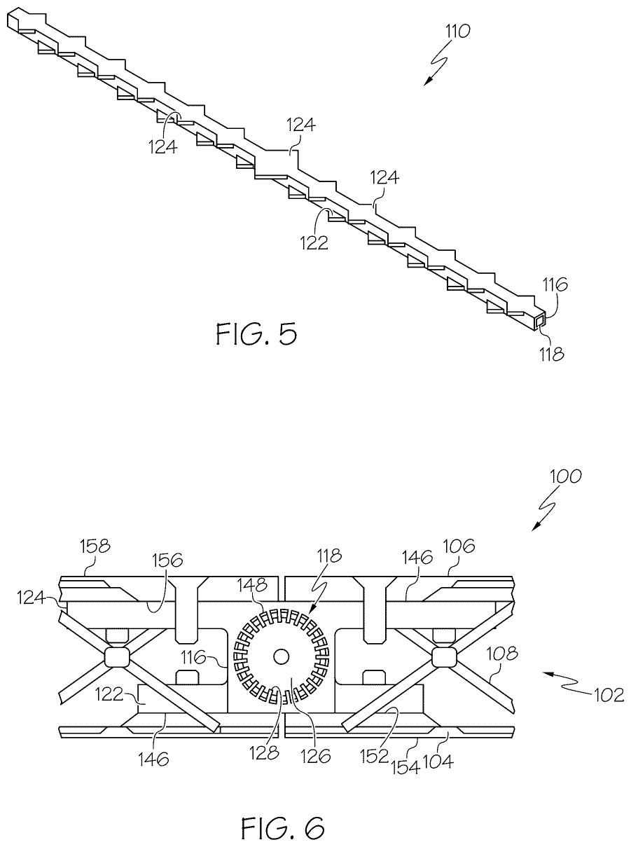

As illustrated in FIG. 5, in one or more examples, the primary splice connector 110 includes a plurality of the first flanges 122. The first flanges 122 extend along the length of the primary splice connector 110 and are spaced apart from each other. The first flanges 122 are at least approximately perpendicular to the body 116. In one or more examples, the primary splice connector 110 includes a plurality of the second flanges 124. The second flanges 124 extend along the length of the primary splice connector 110 and are spaced apart from each other. The second flanges 124 are at least approximately perpendicular to the body 116. The second flanges 124 are opposite the first flanges 122 along the body 116 such that the body forms an interconnecting wed of the primary splice connector 110. In one or more examples, the first flanges 122 and the second flanges 124 are offset from each other along the length of the primary splice connector 110. Generally, the first flanges 122 and the second flanges 124 have a geometry or shape suitable to mate with corresponding sections of the first continuous region 134 of the first face sheet 104 and the second continuous region 138 of the second face sheet 106, respectively.

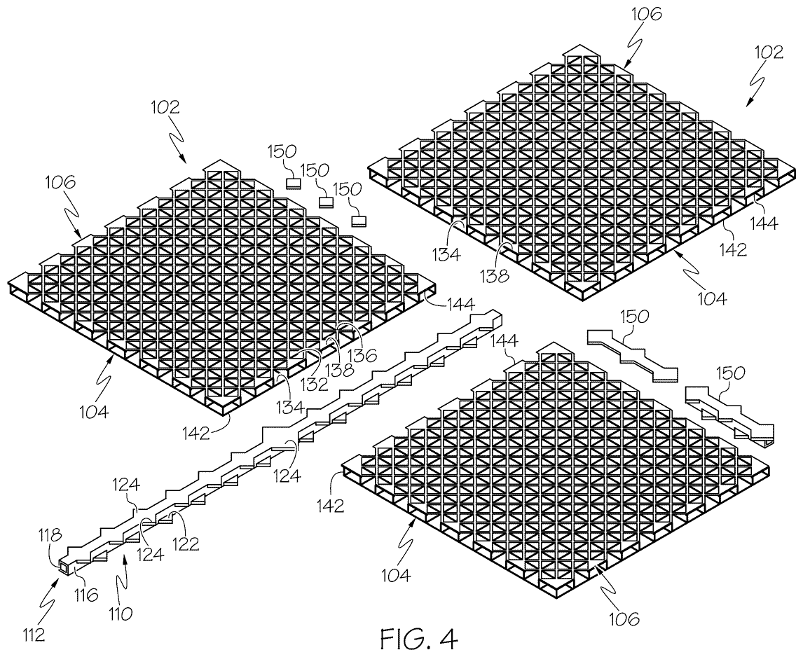

FIGS. 3 and 4 illustrate examples of a plurality of the panels 102 arranged to form the panel assembly 100. In the example of the panel assembly 100 illustrated in FIG. 3, four of the panels 102 are coupled together using one of the primary splice connectors 110. In the examples of the primary splice connector 110 illustrated in FIGS. 3-5, one of the first flanges 122 and/or one of the second flanges 124 of the primary splice connector 110 is configured (e.g., sized and shaped) for connection to all four of the panels 102 at corner or a four-edge interface. The remaining first flanges 122 and/or second flanges 124 of the primary splice connector 110 are configured (e.g., sized and shaped) for connection to two of the panels 102 at a two-edge interface.

As illustrated in FIGS. 1 and 4, in one or more examples, the panel assembly 100 includes a secondary splice connector 150. The panel assembly 100 can include any number (e.g., one or more) of secondary splice connectors 150. In these examples, at least one of the secondary splice connectors 150 is connected to at least one of the first face sheet 104 and the second face sheet 106 along another portion (e.g., second portion) of the perimeter edge 140 of directly adjacent ones of the panels 102 for connecting or further securing together the directly adjacent ones of the panels 102. In one or more examples, at least one of the secondary splice connectors 150 is connected to the first face sheet 104 and at least one of the secondary splice connectors 150 is connected to the second face sheet 106. In one or more examples, at least one of the secondary splice connectors 150 is coupled to first continuous region 134 of the first face sheet 104 along a second portion of the first perimeter edge 142. In one or more examples, at least one of the secondary splice connectors 150 is coupled to second continuous region 138 of the second face sheet 106 along a second portion of the second perimeter edge 144. The secondary splice connector 150 can be coupled to the first inner surface 152 or the first outer surface 154 of the first face sheet 104. The secondary splice connector 150 can be coupled to the second inner surface 156 or the second outer surface 158 of the second face sheet 106.

In one or more examples, the first face sheets 104 and/or the second face sheets 106 being spliced together along a portion of the perimeter edges 140 using the secondary splice connectors 150 facilitates the transfer of panel-to-panel shear. In one or more examples, the shape (e.g., square or diamond) of the secondary splice connectors 150 is configured to match the shape (e.g., square) of adjoined grids of the first continuous regions 134 and/or the second continuous regions 138 of adjacent panels 102.

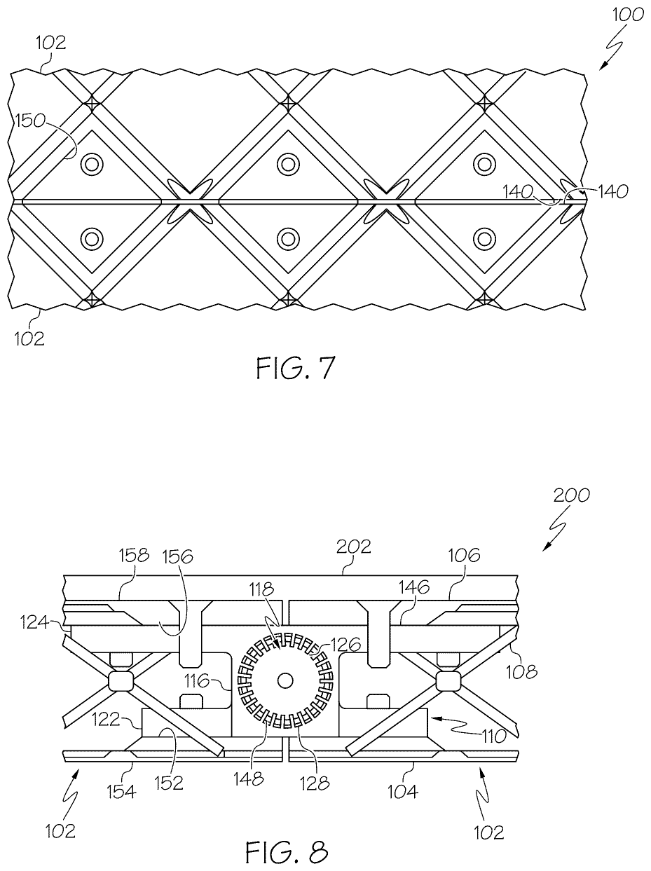

As illustrated in FIG. 7, in one or more examples, the secondary splice connector 150 is configured (e.g., sized and/or shaped) to fit though or between the first lattice region 132 and/or through the truss structure 108 for situating the secondary splice connector 150 on and connecting the secondary splice connector 150 to the second inner surface 156 of the second continuous region 138 after coupling the panels 102 together using the primary splice connector 110. Alternatively, the secondary splice connector 150 is configured (e.g., sized and/or shaped) to fit though or between the second lattice region 136 and/or through the truss structure 108 for situating the secondary splice connector 150 on and connecting the secondary splice connector 150 to the first inner surface 152 of the first continuous region 134 after coupling the panels 102 together using the primary splice connector 110. Situating the secondary splice connector 150 on and connecting the secondary splice connector 150 to the inner surface of the face sheet ensures that the outer surfaces of the panels 102 are planar and generally flat and smooth for connection of the equipment 202.

As illustrated in FIGS. 1, 6 and 8, in one or more examples, the panel assembly 100 includes a thermal interface material 146. The thermal interface material 146 is situated between the primary splice connector 110 and at least one of the first face sheet 104 and the second face sheet 106. The thermal interface material 146 is configured to enhance heat transfer between the heat exchanger 112 of the primary splice connector 110 and the panels 102 coupled together by the primary splice connector 110.

As illustrated in FIGS. 1 and 8, in one or more examples, the panel assembly 100 includes equipment 202 that is coupled to at least one of the first face sheet 104 and the second face sheet 106 or at least one of the panels 102. In these examples, the panel assembly 100 and the equipment 202 form an equipment array 200. In these examples, the equipment 202 can be any suitable type of functional equipment and, more particularly, equipment that generates heat during operation, such as, but not limited to, electrical equipment or components, computing equipment or data processing components, communication equipment, solar cells, and the like.

As illustrated in FIGS. 3, 4 and 7, in one or more examples, the first continuous region 134 extends along the first perimeter edge 142 of the first face sheet 104 of each one of the panels 102 for connection of the first flanges 122 of the primary splice connector 110 and, optionally, one or more of the secondary splice connectors 150 (FIGS. 4 and 7). The second continuous region 138 extends along the second perimeter edge 144 of the second face sheet 106 of each one of the panels 102 for connection of the second flanges 124 of the primary splice connector 110 and, optionally, one or more of the secondary splice connectors 150 (FIGS. 4 and 7).

In various examples, the layout, geometry, and arrangement of the first lattice region 132 and the first continuous region 134 of the first face sheet 104 and of the second lattice region 136 and the second continuous region 138 of the second face sheet 106 provide a number of advantages, including reducing the weight of the panel 102, locating structural support where needed, accommodating passage of wiring and other electrical components through the face sheets, facilitating enhanced thermal transfer, and the like.

In one or more examples, the first continuous region 134 extends along at least a portion of the first perimeter edge 142 of the first face sheet 104. In one or more examples, the first continuous region 134 extends along an entirety of the first perimeter edge 142 of the first face sheet 104. The first continuous region 134 provides a solid, rigid, and/or continuous section of material for support and connection of the primary splice connector 110 between adjacent panels 102.

Similarly, in one or more examples, the second continuous region 138 extends along at least a portion of the second perimeter edge 144 of the second face sheet 106. In one or more examples, the second continuous region 138 extends along an entirety of the second perimeter edge 144 of the second face sheet 106. The second continuous region 138 provides a solid, rigid, and/or continuous section of material for support and connection of the primary splice connector 110 between adjacent panels 102.

As illustrated in FIGS. 6 and 8, in one or more examples, the panels 102 are assembled using full sized determinant assembling and precision holes formed in the panels 102 and the primary splice connectors 110, thereby requiring no shimming or match drilling. In one or more examples, the primary splice connector 110 is coupled to respective first face sheets 104 and second face sheets 106 of the panels 102 using mechanical fasteners (e.g., bolts as shown in FIGS. 6 and 8).

In one or more examples, the first face sheet 104 and the second face sheet 106 are at least approximately parallel to each other. In one or more examples, the panel 102, the first face sheet 104, and the second face sheet 106 may be understood to have a planar extent. As an example, the panel 102, the first face sheet 104, and the second face sheet 106 are generally planar when viewed along at least orthogonal axis or direction. For example, the panel 102 can take the form of a flat panel. In one or more examples, the panel 102, the first face sheet 104, and the second face sheet 106 have curvature and/or more complex geometry. As an example, the panel 102, the first face sheet 104, and the second face sheet 106 can be non-planar or otherwise include some degree or curvature or contour in one or more directions.

In one or more examples, at least a portion of the first face sheet 104 along the first perimeter edge 142 of one panel 102 is configured to match a profile and align with at least a portion of the first face sheet 104 along the first perimeter edge 142 of an adjacent panel 102 such that the first flanges 122 of the primary splice connector 110 and, optionally, the secondary splice connectors 150 can extend across the aligned first perimeter edges 142 of the adjacent panels 102. In one or more examples, at least a portion of the second face sheet 106 along the second perimeter edge 144 of one panel 102 is configured to match a profile and align with at least a portion of the second face sheet 106 along the second perimeter edge 144 of an adjacent panel 102 such that the second flanges 124 of the primary splice connector 110 and, optionally, the secondary splice connectors 150 can extend across the aligned second perimeter edges 144 of the panels 102.

Examples of the panel assembly 100 can include any number of panels 102. The panels 102 are coupled together in a desired arrangement or configuration using one or more of the primary splice connectors 110 and, optionally, one or more of the secondary splice connectors 150 based on the intended use or application. Examples of the panel assembly 100 can include any number of primary splice connectors 110 and/or secondary splice connectors 150, for example, depending on the number and arrangement of the panels 102.

Referring now to FIGS. 1 and 8, by way of examples, the present disclosure is also directed to the equipment array 200. The following are examples of the equipment array 200, according to the present disclosure. Examples of the equipment array 200 include a number of elements, features, and components. In one or more examples, the equipment array 200 is constructed or otherwise fabricated using the panel assembly 100 (FIGS. 1 and 3-8) and/or according to the method 1000 (FIG. 2). Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

In one or more examples, the equipment array 200 includes a plurality of the panels 102. Each one of the panels 102 includes the first face sheet 104, the second face sheet 106, the truss structure 108 connecting the first face sheet 104 and the second face sheet 106, and the perimeter edge 140. The equipment array 200 includes at least one of the primary splice connectors 110 that is connected to the first face sheet 104 and the second face sheet 106 along at least a portion of the perimeter edge 140 of directly adjacent ones of the panels 102. The primary splice connector 110 includes the heat exchanger 112. The equipment array 200 includes the equipment 202 that is coupled to at least one of the first face sheet 104 and the second face sheet 106 of at least one of the panels 102. The primary splice connector 110 is configured to transfer heat along the panels 102 and is configured to react to a structural load across the panels 102.

In various examples, the equipment array 200 is modular and offers a variety of benefits and advantages compared to traditional equipment service racks. The equipment array 200 advantageously enables modular design and assembly of various types and numbers of equipment. The panels 102 that support the equipment 202 advantageously accommodate wiring, cables, connectors, and other operational components associated with the equipment 202, which can be situated under the equipment 202 and/or be routed through the lattice regions of the face sheets and/or the core truss structure of the panels 102. In various examples, the equipment array 200 advantageously enables highly efficient heat transfer (e.g., versus conventional composite substrate) because the heat exchange capability of the splice connectors enables heat to spread along and/or through the panels 102 and the equipment 202 can radiate heat directly to open space through the lattice structure and core truss structure of the panels 102, rather than conducting through a honeycomb core. In various examples, the equipment array 200 advantageously enables design flexibility in multiple dimensions, including modularity, panel size, face sheet thickness, truss core thickness, panel thickness, panel geometry, panel symmetry, heat transfer paths, and the like, which provides selectively variable face sheet thicknesses and core densities at no additional manufacturing cost. In various examples, each one of the panels 102 can be designed using a predetermined geometric increment (e.g., 1 inch) and additively manufactured to include a suitable number of geometric increments. The manufactured panels 102 can then be tailored and assembled in a suitable configuration or array for connection of any feasible number of electrical equipment or components to form the equipment array 200 of any feasible desired size (e.g., 13″×13″, 15″×19″, etc.). In various examples, additively manufacturing the panels 102 of the equipment array 200 advantageously eliminates the use of composite substrates, which are typically a long lead item. In various examples, additively manufacturing the panels 102 advantageously provide connection fittings that are integral to the panel structure, which eliminates the requirements for bonding and proof loading embedded fittings that tend to delaminate under temperature extremes.

Referring now to FIG. 2, by way of examples, present disclosure is also directed to the method 1000 for manufacturing and using the panel assembly 100 and/or the equipment array 200. The following are examples of the method 1000, according to the present disclosure. Examples of the method 1000 include a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

In one or more examples, the method 1000 includes a step of manufacturing 1002 a plurality of the panels 102. Each one of the panels 102 includes the first face sheet 104, the second face sheet 106, the truss structure 108 connecting the first face sheet 104 and the second face sheet 106, and the perimeter edge 140.

In one or more examples, the step of manufacturing 1002 the panels 102 includes a step of additively manufacturing each one of the panels 102 from a metallic alloy using laser powder fusion. In one or more examples, according to the method 1000, the step of additively manufacturing each of the panels 102 includes a step of additively manufacturing the first face sheet 104, a step of additively manufacturing the truss structure 108 integrally with the first face sheet 104, and a step of additively manufacturing the second face sheet 106 integrally with the truss structure 108.

In one or more examples, the method 1000 includes a step of manufacturing 1004 one or more of the primary splice connectors 110. The primary splice connector 110 (e.g., each one of the primary splice connectors 110) includes the body 116 including the bore 118 that extends along the longitudinal axis 120 or the body 116. The primary splice connector 110 includes the first flange 122 that extends from the body 116. The primary splice connector 110 includes the second flange 124 that extends from the body 116.

In one or more examples, the method 1000 includes a step of connecting 1006 each one of the panels 102 to a directly adjacent one of the panels 102 along at least a portion of the perimeter edge 140 using at least one of the primary splice connectors 110. The primary splice connector 110 (e.g., each one of the primary splice connectors 110) includes the heat exchanger 112.

In one or more examples, according to the method 1000, the step of connecting 1006 includes a step of positioning the primary splice connector 110 between the perimeter edge 140 of each directly adjacent one of the panels 102, a step of coupling the first flange 122 to the first face sheet 104, and step of coupling the second flange 124 to the second face sheet 106.

In one or more examples, according to the method 1000, the step of connecting 1006 also includes a step of applying the thermal interface material 146 between the primary splice connector 110 and at least one of the first face sheet 104 and the second face sheet 106.

In one or more examples, the method 1000 includes a step of coupling 1008 the equipment 202 to at least one of the panels 102. In these examples, the equipment 202 can be coupled to the first face sheet 104 and/or the second face sheet 106 of one or more of the panels 102 of the panel assembly 100.

In one or more examples, the method 1000 includes a step of transferring 1010 heat along the panels 102. Heat is transferred using the primary splice connector 110. In these examples, heat, for example, generated by the equipment 202, is distributed or spread across and/or through the panels 102 via the heat exchanger 112 (e.g., heat pipe 114) that is integrated in the body 116 of the primary splice connector 110.

In one or more examples, the method 1000 includes a step of reacting 1012 to one or more structural loads. The structural load (e.g., tension, shear, torsion, moment, etc.) applied to or across the panels 102 is reacted using the primary splice connector 110. In these examples, a structural load applied to or across the panels 102 is reacted by the body 116 and flanges 130 of the primary splice connector 110.

In one or more examples, each of the panels 102 is additively manufactured. Additive manufacturing enables the panels 102 to be made in various dimensions and configurations depending on the heat transfer requirements of the equipment array 200. Additive manufacturing also enables the geometry and relative locations and arrangement of the first lattice region 132 and the first continuous region 134 of the first face sheet 104 and the second lattice region 136 and the second continuous region 138 of the second face sheet 106 to be selectively controlled depending on the structural, weight, and thermal transfer requirements of the equipment array 200. In one or more examples, the panels 102 are additively manufactured from a metallic allow, such as a high strength aluminum alloy, using laser powderbed fusion, which provides a yield strength of greater than 50 ksi. However, in other examples, other metallic materials and/or other additive manufacturing processes can be used to manufacture the panels 102.

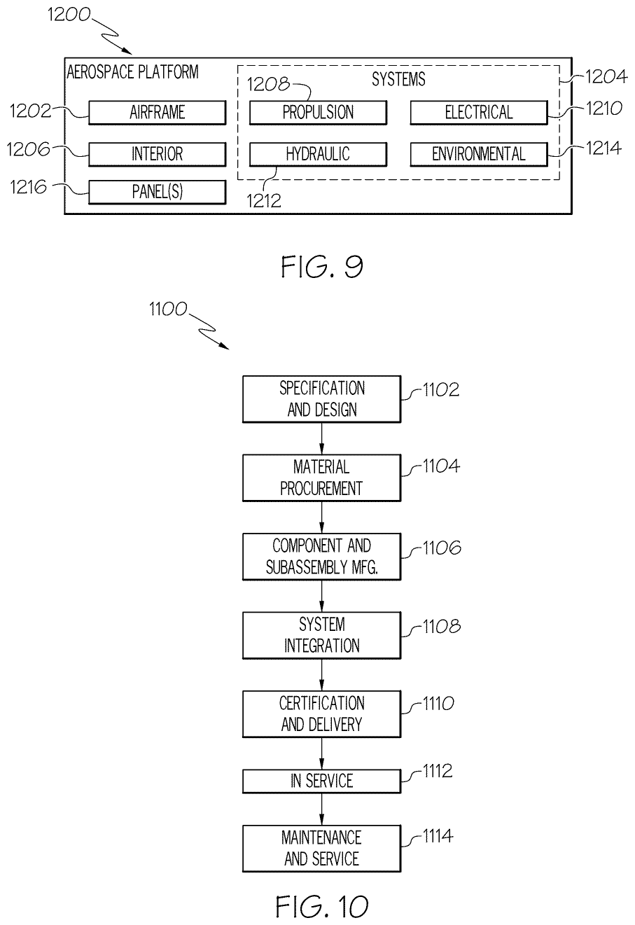

Referring now to FIGS. 9 and 10, examples of the panel assembly 100, the equipment array 200, and the method 1000, described herein, may be related to, or used in the context of, an aerospace platform 1200, as schematically illustrated in FIG. 9 and/or an aerospace manufacturing and service method 1100, as shown in the flow diagram of FIG. 10. As an example, the aerospace platform 1200 may include various equipment racks that require thermal control that is provided using the panel assembly 100.

Referring to FIG. 9, which illustrates an example of the aerospace platform 1200. The aerospace platform 1200 is an example of a mobile platform 250 (FIG. 1). The aerospace platform 1200 can be any aerospace vehicle or platform, such as an aircraft, a spacecraft, a satellite, and the like. In one or more examples, the aerospace platform 1200 includes an airframe 1202 having an interior 1206. The aerospace platform 1200 includes a plurality of onboard systems 1204 (e.g., high-level systems). Examples of the onboard systems 1204 of the aerospace platform 1200 include propulsion systems 1208, hydraulic systems 1212, electrical systems 1210, and environmental systems 1214. In other examples, the onboard systems 1204 also includes one or more control systems coupled to the airframe 1202 of the aerospace platform 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like. In these examples, the aerospace platform 1200 can have any number of electrical components or other equipment (e.g., equipment 202) that require arrangement, securement, and thermal control using panels 1216. In these examples, one or more of the panels 1216 are examples of the panels 102 (FIG. 1).

While explicit examples of the panel assembly 100 and equipment array 200 are described and illustrated as being used with aerospace platforms or vehicles, in other examples, the panel assembly 100 and equipment array 200 can be used with various other types of vehicles (e.g., land, sea, etc.), mobile platforms, or fixed structures that include or utilize equipment 202 requiring thermal control.

Referring to FIG. 10, during pre-production of the aerospace platform 1200, the manufacturing and service method 1100 includes specification and design 1102 of the aerospace platform 1200 and material procurement 1104. During production of the aerospace platform 1200, component and subassembly manufacturing 1106 and system integration 1108 of the aerospace platform 1200 take place. Thereafter, the aerospace platform 1200 goes through certification and delivery 1110 to be placed in service 1112. Routine maintenance and service 1114 includes modification, reconfiguration, refurbishment, etc. of one or more systems of the aerospace platform 1200.

Each of the processes of the manufacturing and service method 1100 illustrated in FIG. 10 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the panel assembly 100, the equipment array 200, and the method 1000, shown and described herein, may be employed during any one or more of the stages of the manufacturing and service method 1100 shown in the flow diagram illustrated by FIG. 10. In an example, equipment 202 of the aerospace platform 1200 can be installed using the panel assembly 100 and/or according to the method 1000 during a portion of component and subassembly manufacturing 1106 and/or system integration 1108. Further, equipment 202 of the aerospace platform 1200 can be installed using the panel assembly 100 and/or according to the method 1000 while the aerospace platform 1200 is in service 1112. Also, equipment 202 of the aerospace platform 1200 can be installed using the panel assembly 100 and/or according to the method 1000 during system integration 1108 and certification and delivery 1110. Similarly, equipment 202 of the aerospace platform 1200 can be installed using the panel assembly 100 and/or according to the method 1000 while the aerospace platform 1200 is in service 1112 and during maintenance and service 1114.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

As used herein, the term “ones” refers to individual items relative to a plurality of the items, such as specific group of the items or a selected individual item of the items. As an example, the term “directly adjacent ones” refers to at least a first one and a second one of a plurality of items that are directly adjacent to each other (e.g., two items next to each other without another one of the items in between). For the purpose of the present disclosure, directly adjacent ones of the items can also be understood to refer to a directly adjacent pair of the items or directly adjacent pairs of the items.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1 and 3-9, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1 and 3-9, referred to above, need be included in every example and not all elements, features, and/or components described herein are necessarily depicted in each illustrative example. Accordingly, some of the elements, features, and/or components described and illustrated in FIGS. 1 and 3-9 may be combined in various ways without the need to include other features described and illustrated in FIGS. 1 and 3-9, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1 and 3-9, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1 and 3-9, and such elements, features, and/or components may not be discussed in detail herein with reference to each of FIGS. 1 and 3-9. Similarly, all elements, features, and/or components may not be labeled in each of FIGS. 1 and 3-9, but reference numerals associated therewith may be utilized herein for consistency.

In FIGS. 2 and 10, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 2 and 10 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need to be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the panel assembly 100, the equipment array 200, and the method 1000 have been shown and described, modifications may occur to those skilled in the art upon reading the specification. The present application includes such modifications and is limited only by the scope of the claims.

What is claimed is:

1. A panel assembly comprising:
a plurality of panels, each one comprising:
a first face sheet;
a second face sheet;
a truss structure connecting the first face sheet and the second face sheet; and
a perimeter edge; and
a primary splice connector connected to the first face sheet and the second face sheet along at least a portion of the perimeter edge of directly adjacent ones of the panels,
wherein the primary splice connector is configured to react to a structural load across the panels and comprises a heat exchanger configured to transfer heat along the panels.

2. The panel assembly of claim 1, wherein the heat exchanger comprises a heat pipe.

3. The panel assembly of claim 1, further comprising a thermal interface material situated between the primary splice connector and at least one of the first face sheet and the second face sheet.

4. The panel assembly of claim 1, wherein the heat exchanger comprises:
a body comprising a bore extending along a longitudinal axis, wherein the bore comprises a core portion and a wick portion coupled to the core portion;
a first flange extending from the body and coupled to the first face sheet; and
a second flange extending from the body and coupled to the second face sheet.

5. The panel assembly of claim 4, wherein:
the first face sheet comprises a first lattice region, a first continuous region; and a first perimeter edge;
the first continuous region extends along at least a portion of the first perimeter edge; and
the first flange is coupled to the first continuous region.

6. The panel assembly of claim 5, wherein:
the first face sheet further comprises a first inner surface and a first outer surface; and
the first flange is coupled to the first inner surface.

7. The panel assembly of claim 4, wherein:
the second face sheet comprises a second lattice region, a second continuous region; and a second perimeter edge;
the second continuous region extends along at least a portion of the second perimeter edge; and
the second flange is coupled to the second continuous region.

8. The panel assembly of claim 7, wherein:
the second face sheet further comprises a second inner surface and a second outer surface; and
the second flange is coupled to the second inner surface.

9. The panel assembly of claim 1, further comprising a secondary splice connector connected to the first face sheet and the second face sheet along another portion of the perimeter edge.

10. The panel assembly of claim 1, wherein the primary splice connector extends between the first face sheet and the second face sheet.

11. The panel assembly of claim 1, wherein each of the panels is additively manufactured from a metallic alloy using laser powder fusion.

12. The panel assembly of claim 1, wherein the truss structure comprises a plurality of truss members, and each one of the truss members is integral with the first face sheet and the second face sheet, such that the first face sheet, the second face sheet, and the truss structure collectively form a single monolithic joint-free structure.

13. The panel assembly of claim 1, further comprising equipment coupled to at least one of the first face sheet and the second face sheet of at least one of the panels.

14. An equipment array comprising:
a plurality of panels, each one comprising:
a first face sheet;
a second face sheet;
a truss structure connecting the first face sheet and the second face sheet; and
a perimeter edge;
a primary splice connector connected to the first face sheet and the second face sheet along at least a portion of the perimeter edge of directly adjacent ones of the panels, wherein the primary splice connector comprises a heat exchanger; and
equipment coupled to at least one of the first face sheet and the second face sheet of at least one of the panels,
wherein the primary splice connector is configured to transfer heat along the panels and to react to a structural load across the panels.

15. The equipment array of claim 14, wherein the heat exchanger comprises a heat pipe.

16. A method comprising:
manufacturing a plurality of panels, wherein each one of the panels comprises:
a first face sheet;
a second face sheet;
a truss structure connecting the first face sheet and the second face sheet; and
a perimeter edge; and
connecting each one of the panels to a directly adjacent one of the panels along at least a portion of the perimeter edge using a primary splice connector, wherein the primary splice connector comprises a heat exchanger.

17. The method of claim 16, further comprising manufacture the primary splice connector comprising:
a body comprising a bore extending along a longitudinal axis;
a first flange extending from the body; and
a second flange extending from the body,
wherein connecting each one of the panels comprises:
positioning the primary splice connector between the perimeter edge of each directly adjacent one of the panels;
coupling the first flange to the first face sheet; and
coupling the second flange to the second face sheet.

18. The method of claim 16, further comprising coupling equipment to at least one of the panels.

19. The method of claim 16, further comprising:
transferring heat along the panels using the primary splice connector; and
reacting to a structural load across the panels using the primary splice connector.

20. The method of claim 16, wherein manufacturing the panels comprises additively manufacturing each one of the panels from a metallic alloy using laser powder fusion.
